(19) United States
(12) Patent Application Publication
(10) Pub. No.: US 2024/0151826 A1
(43) Pub. Date: May 9, 2024

(54) LIDAR MEMS ANGLE ADJUSTMENT

(71) Applicant: OSRAM GMBH, München (DE)

(72) Inventor: Martin Schnarrenberger, Berlin (DE)

(21) Appl. No.: 18/000,085

(22) PCT Filed: May 7, 2021
(86) PCT No.: PCT/EP2021/062199

§ 371 Date: Nov. 28, 2022

(30) Foreign Application Priority Data
May 26, 2020 (DE) 10 2020 206 537.3

(51) Int. Cl. G01S 7/481

(52) U.S. Cl. CPC G01S 7/4817

(57) ABSTRACT

According to various embodiments, an optical arrangement (200) for a LIDAR system can have: a focusing arrangement (202) which is configured in such a way that it focuses light onto a focal point (214) of the focusing arrangement (202); a beam deflection component (204) arranged downstream of the focusing arrangement (202) at a first distance (216) from the focal point (214) of the focusing arrangement (202), wherein the beam deflection component (204) is configured to deflect the light at a deflection angle onto a field of view (220); and a collimating lens (206) arranged downstream of the beam deflection component (204) at a second distance (218) from the focal point (214) of the focusing arrangement (202), wherein the second distance (218) corresponds to a focal length of the collimating lens (206), and wherein the collimating lens (206) is configured to parallelize the light from the focal point (214).

Various exemplary embodiments relate to an optical arrangement for a LIDAR system (i.e., for a “Light Detection And Ranging” system).

In a LIDAR system having beam deflection, the components that match with the application are not always available. In particular, MEMS mirrors are difficult to qualify and are only available for a few different deflection angles (for example from −15° to +15°). These deflection angles often do not match with the required field of view because each application has a different field of view (for example from 10° to 150°). If additional optical beam deflection components are used (for example a liquid crystal polarization grating (LCPG)), the field of view can also have values around 6°. This problem exists for both 1D and 2D beam deflection systems. For example, a beam deflection system can be based on MEMS, galvo scanners, meta-materials, or inductively moved lenses or mirrors.

Various embodiments relate to an optical arrangement for a LIDAR system which enables a flexible and simple adjustment of the field of view of the LIDAR system. The optical arrangement is configured in such a way that the field of view of the LIDAR system is decoupled from the beam deflection area (also referred to as the emission field) of a beam deflection component. The operation of the beam deflection component (also referred to as beam deflection element) thus does not restrict the achievable field of view of the LIDAR system. The decoupling of the emission field of the beam deflection element from the field of view of the LIDAR system is achieved by the relative arrangement of the beam deflection component and a collimating lens in relation to a focal point of a focusing arrangement.

According to various embodiments, an optical arrangement for a LIDAR system can have the following: a focusing arrangement configured in such a way that it focuses light onto a focal point of the focusing arrangement;

a beam deflection component arranged downstream of the focusing arrangement at a first distance from the focal point of the focusing arrangement, wherein the beam deflection component is configured to deflect the light at a deflection angle (also referred to as a deflecting angle) onto a field of view; and a collimating lens arranged downstream of the beam deflection component at a second distance from the focal point of the focusing arrangement, wherein the second distance corresponds to a focal length of the collimating lens, and wherein the collimating lens is arranged in such a way that it parallelizes (in other words, collimates) the light from the focal point of the focusing arrangement. The optical arrangement described in this paragraph provides a first example.

The parallellizing of the light emitted into the field of view (for example the emitted light beams) is made possible by the arrangement of the collimating lens at a distance from the focal point, which distance corresponds to the focal length of the collimating lens. The arrangement of the beam deflection component outside the focal point makes it possible to vary the (virtual) position of the focal point as seen from the collimating lens and to change the exit angle of the light downstream of the collimating lens accordingly. In the context of this description, the term “collimating lens” can be understood as an arrangement having one or more optical components (for example one or more lenses) which is (are) set up to parallelize the light coming from the focal point of the focusing arrangement.

According to various embodiments, the deflection angle of the deflected light downstream of the beam deflection component can define a virtual position of the focal point of the focusing arrangement with respect to the collimating lens. For example, the deflection angle can be an angle in relation to an optical axis of the optical arrangement. The features described in this paragraph in combination with the first example provide a second example.

Each virtual position can be the same distance from the collimating lens as any other virtual position. The distance can be the focal length of the collimating lens or can correspond to the focal length of the collimating lens. Each virtual position can define or be assigned to an exit angle of the light downstream of the collimating lens.

The collimating lens can see a different position for the focal point of the focusing arrangement for each different deflection angle (for example, for each operating state of the beam deflection component). Clearly, varying the deflection angle can cause the collimating lens to see the received light as if the light came from various origin points (the various positions of the focal point), and accordingly to parallelize the light at different exit angles (for example, in order to scan the field of view).

According to various embodiments, the beam deflection component can have at least two operating states, wherein each operating state of the at least two operating states is associated with a respective deflection angle of the deflected light downstream of the beam deflection component. The features described in this paragraph in combination with the first or the second example provide a third example.

According to various embodiments, the beam deflection component can be configured in such a way that it deflects the light at a first deflection angle with respect to the optical axis of the optical arrangement in a first operating state of the at least two operating states, and that it deflects the light at a second deflection angle with respect to the optical axis of the optical arrangement in a second operating state of the least two operating states. The features described in this paragraph in combination with one of the first to third examples provide a fourth example.

According to various embodiments, the collimating lens can be configured in such a way that it maps the light coming into the collimating lens from the focal point of the focusing arrangement onto collimated (parallelized) light at an exit angle (for example, an angle with respect to the optical axis of the optical arrangement). The features described in this paragraph in combination with one of the first to fourth examples provide a fifth example.

As an example, the collimating lens can be configured in such a way that it maps light, which is deflected at a first deflection angle and comes into the collimating lens from a first (for example virtual) focal point of the focusing arrangement, onto collimated light at a first exit angle, and that it maps light, which is deflected at a second deflection angle and comes from a second (for example virtual) focal point of the focusing arrangement, onto collimated light at a second exit angle.

According to various embodiments, the exit angle of the collimated light downstream of the collimating lens can be dependent on (for example, can be proportional to) a ratio between the first distance and the second distance (for example, a ratio of the first distance to the second distance). The features described in this paragraph in combination with the fifth example provide a sixth example.

For example, the exit angle of the collimated light downstream of the collimating lens can be dependent on the deflection angle of the deflected light downstream of the beam deflection component (for example, the exit angle can be proportional to the deflection angle).

According to various embodiments, the deflection angle can have a value in a range from approximately −60° to approximately +60° in relation to the optical axis of the optical arrangement, for example, in a range from approximately −30° to approximately +30°.

It is understood that the ranges (beam deflection ranges) described herein serve only as a numerical example and other ranges are possible, for example, depending on a configuration (for example, a type) of the beam deflection component. The features described in this paragraph in combination with one of the first to sixth examples provide a seventh example.

According to various embodiments, the deflection angle can have a first deflection angle element in a first direction and a second deflection angle element in a second direction. Clearly, the first deflection angle element can be associated with scanning the field of view in the first direction, and the second deflection angle element can be associated with scanning the field of view in the second direction. The features described in this paragraph in combination with one of the first to seventh examples provide an eighth example.

For example, the first deflection angle element can have a value in a range from approximately −60° to approximately +60° in relation to the optical axis of the optical arrangement, for example, in a range from approximately −30° to approximately +30°. The second deflection angle element can have a value in a range from approximately −60° to approximately +60° in relation to the optical axis of the optical arrangement, for example, in a range from approximately −30° to approximately +30°.

The second direction can be perpendicular to the first direction, for example. As a nonrestrictive example, the first field of view direction can be the horizontal direction and the second field of view direction can be the vertical direction.

According to various embodiments, at least one of the first deflection angle element or the second deflection angle element can have a value of 0° independently of an operating state of the beam deflection component. This can be the case if the optical arrangement will be or is configured for one-dimensional scanning of the field of view. The features described in this paragraph in combination with one of the first to eighth examples provide a ninth example.

According to various embodiments, an exit angle of the collimated light downstream of the collimating lens can have a value in a range from approximately −20° to approximately +20° with respect to the optical axis of the optical arrangement, for example in a range from approximately −5° to approximately +5°, for example in a range from approximately −50° to approximately +50°. It is understood that the ranges described herein serve only as a numerical example and further ranges are possible, for example, depending on a configuration (for example a type) of the collimating lens or a desired adjustment of the field of view with respect to the beam deflection range. The features described in this paragraph in combination with one of the first to ninth examples provide a tenth example.

According to various embodiments, the exit angle can have a first exit angle element in a first direction (for example in the horizontal direction) and a second exit angle element in a second direction (for example in the vertical direction) (in a similar manner as described above with respect to the deflection angle). The features described in this paragraph in combination with the tenth example provide an eleventh example.

According to various embodiments, the optical arrangement can furthermore have one or more processors configured to control the beam deflection component in such a way that it goes into one operating state of at least two operating states (for example of a plurality of operating states), wherein each operating state is associated with a respective deflection angle. The features described in this paragraph in combination with one of the first to eleventh examples provide a twelfth example.

For example, the one or more processors can be configured to control the beam deflection component in such a way that it successively goes into each operating state of the at least two operating states (for example, into each or into some of the operating states of the plurality of operating states).

According to various embodiments, the one or more processors can furthermore be configured to control the beam deflection component in such a way that it goes into an operating state to define a predefined virtual position of the focal point of the focusing arrangement with respect to the collimating lens. The features described in this paragraph in combination with the twelfth example provide a thirteenth example.

In other words, the one or more processors can be configured to control the beam deflection component such that it provides a deflection angle at which the collimating lens sees the focal point of the focusing arrangement at a predefined (for example, desired) position. The control of the beam deflection component can thus allow an adjustment of the (virtual) position of the focal point as seen by the collimating lens, in order to compensate for a possible positioning error of the collimating lens with respect to the focal point.

According to various embodiments, the collimating lens can be or have a cylindrical lens, an acylindrical lens, or an aspheric lens. The configuration of the collimating lens (for example, the type of lens or optical components) can be chosen depending on the type of scanning of the field of view (for example, one-dimensional or two-dimensional). The features described in this paragraph in combination with one of the first to thirteenth examples provide a fourteenth example.

According to various embodiments, the focusing arrangement can be configured in such a way that the focal point of the focusing arrangement lies between the focusing arrangement and the beam deflection component or that the focal point of the focusing arrangement lies between the beam deflection component and the collimating lens. The features described in this paragraph in combination with one of the first to fourteenth examples provide a fifteenth example.

The position of the focal point of the focusing arrangement (upstream or downstream of the beam deflection component) therefore does not negatively affect the function of the optical arrangement, insofar as the relative arrangement between the focal point, the collimating lens, and the beam deflection component is ensured.

According to various embodiments, the focusing arrangement can include one or more optical components (for example one or more lenses). The one or more lenses can include a first collimator lens (also referred to as a first collimation lens). For example, the first collimator lens can be or include a cylindrical lens, for example, a “fast axis” collimator lens. The one or more lenses can furthermore (optionally) include a second collimator lens (also referred to as a second collimation lens). For example, the second collimator lens can be or include a cylindrical lens, for example, a “slow axis” collimator lens. The features described in this paragraph in combination with one of the first to fifteenth examples provide a sixteenth example.

According to various embodiments, the beam deflection component can be or include a microelectromechanical system. For example, the microelectromechanical system can be an optical “phased array,” a metamaterial surface, or a mirror. The features described in this paragraph in combination with one of the first to sixteenth examples provide a seventeenth example.

According to various embodiments, the beam deflection component can be a microelectromechanical mirror which is configured in such a way that it rotates around an actuation axis (for example, perpendicularly to the optical axis of the optical arrangement and/or perpendicularly to the scanning direction) of the microelectromechanical mirror. The features described in this paragraph in combination with the seventeenth example provide an eighteenth example.

A tilt angle of the microelectromechanical mirror with respect to the axis of actuation can define the deflection angle of the redirected light downstream of the microelectromechanical mirror. The microelectromechanical mirror can be configured to deflect light at a first deflection angle if the microelectromechanical mirror is at a first tilt angle with respect to the actuation axis, and to deflect light at a second deflection angle if the microelectromechanical mirror is at a second tilt angle with respect to the actuation axis.

According to various embodiments, one or more processors of the optical arrangement can be configured to control an oscillation of the microelectromechanical mirror around the actuation axis. For example, the one or more processors can furthermore be configured to associate an offset angle with each tilt angle of the microelectromechanical mirror, such that each tilt angle defines a predefined virtual position of the focal point of the focusing arrangement in relation to the collimating lens (for example, to compensate for a positioning error of the collimating lens). The features described in this paragraph in combination with the eighteenth example provide a nineteenth example.

According to various embodiments, the optical arrangement can furthermore include a light source which is configured in such a way that it emits light in the direction of the focusing arrangement. The features described in this paragraph in combination with one of the first to nineteenth examples provide a twentieth example.

As an example, the light source can be or include a laser light source (for example, a laser diode or laser bar).

According to various embodiments, one or more processors of the optical arrangement can be configured to control the light source in such a way that it emits light in accordance (for example in synchronization) with an operating state of the beam deflection component. The features described in this paragraph in combination with the twentieth example provide a twenty-first example.

The one or more processors can be configured to control the light source (for example a timing of the light emission) in such a way that the light source emits light in synchronization with an operating state of the beam deflection component, which operating state defines a predefined position of the focal point of the focusing arrangement with respect to the collimating lens or is associated with a predefined position of the focal point.

In other words, the one or more processors can control the light source in such a way that it emits light at a time when the beam deflection component provides a deflection angle that defines a predefined (for example, desired) position of the focal point of the focusing arrangement as seen from the collimating lens.

Clearly, the control of the light emission can compensate for possible positioning errors of the collimating lens.

For example, the one or more processors can be configured to control the timing of light emission (as described above) if misalignment of the collimating lens is detected (for example, measured), for example by a detection system of the optical arrangement (or the LIDAR system including the optical arrangement).

Exemplary embodiments of the invention are illustrated in the figures and will be described in greater detail hereinafter.

Wherein

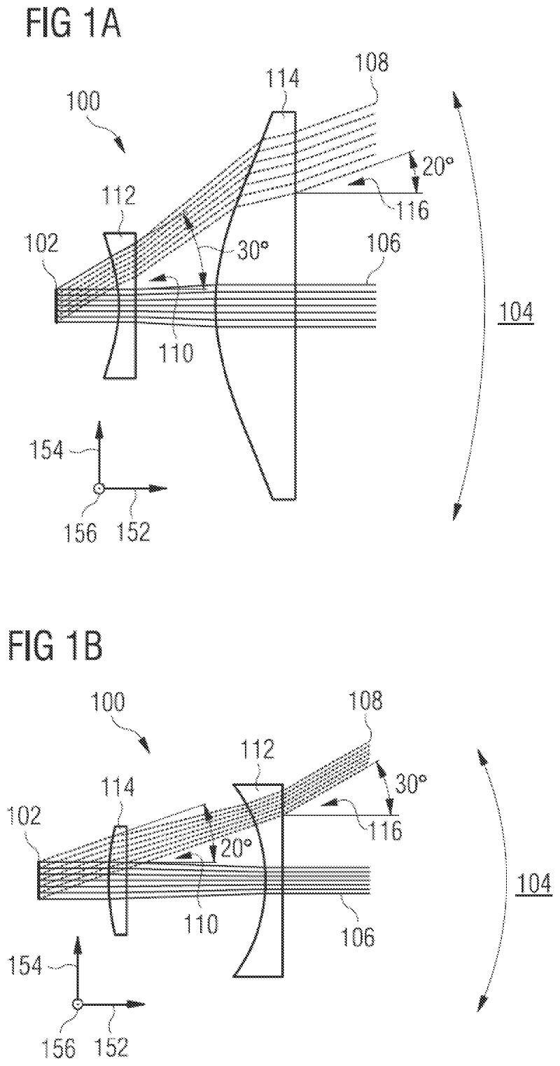

FIGS. 1A and 1B each show a schematic representation of an optical arrangement for a LIDAR system according to various embodiments.

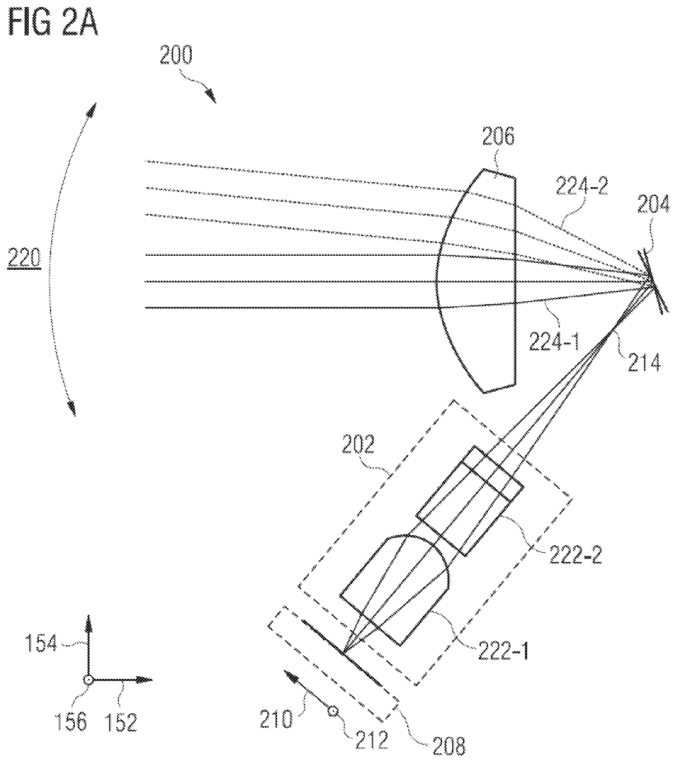

FIGS. 2A and 2B each show a schematic representation of an optical arrangement for a LIDAR system according to various embodiments.

In the following detailed description, reference is made to the accompanying drawings, which form a part of this description and in which specific embodiments in which the invention can be implemented are shown for illustration. Because components of embodiments can be positioned in a number of different orientations, the directional terminology is used for purposes of illustration and is in no way restrictive. It is understood that other embodiments can be utilized and structural or logical changes can be made without departing from the scope of protection of the present invention. It is understood that the features of the various exemplary embodiments described herein can be combined with one another unless specifically stated otherwise. The following detailed description is therefore not to be interpreted in a restrictive sense, and the scope of protection of the present invention is defined by the appended claims. In the figures, identical or similar elements are provided with identical reference numerals, insofar as this is appropriate.

Figure LA and FIG. 1B each show a top view of an optical arrangement 100 for a LIDAR system in a schematic representation.

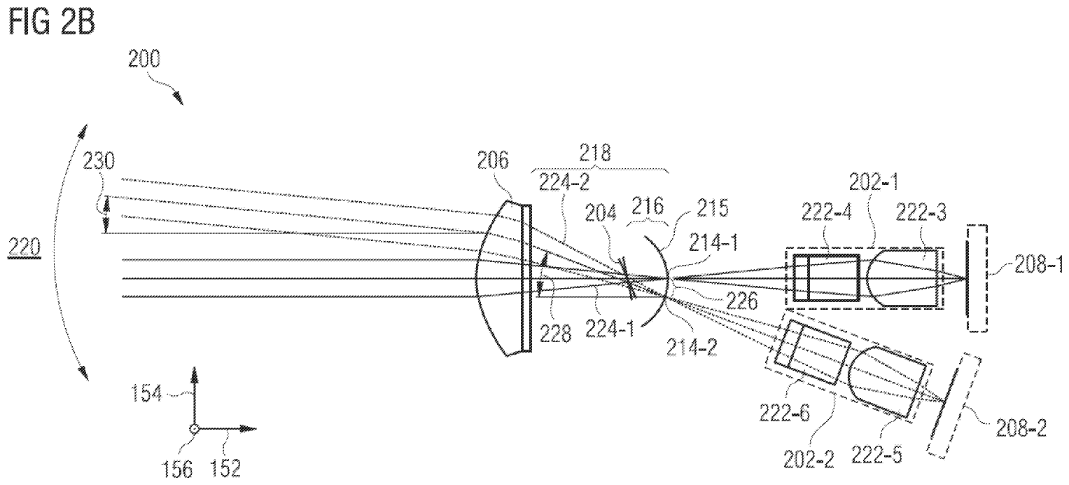

The optical arrangement 100 can include a beam deflection component 102 for deflecting light in the direction of a field of view 104 (for example, a field of view of the optical arrangement 100 or a field of view of the LIDAR system). The beam deflection component 102 can be controlled to deflect light at different deflection angles. Clearly, the beam deflection component 102 can be configured to scan the field of view 104 in one scanning direction (or in two scanning directions). For example, the beam deflection component 102 can be controlled to deflect an input light beam (not shown in the figure for the sake of clarity) in a first operating state into a first light beam 106 at a first deflection angle (for example, 0°) and to deflect it in a second operating state into a second light beam 108 at a second deflection angle 110 (for example, 30° as shown in FIG. 1A or 20° as shown in FIG. 1B). Parallel beams can originate from the beam deflection component 102.

In the case that the field of view 104 is not identical to the deflection angle of the beam deflection component 102, the field of view 104 can be adjusted using correction lenses behind (in other words, downstream of) the beam deflection component 102. Clearly, the angle range of the field of view 104 (also referred to as the field of view range) can be adjusted by means of one or more correction lenses if the desired angle range in the field of view 104 does not correspond to the beam deflection range.

For example, the adjustment can be carried out by a diverging lens 112, which expands the (for example first and/or second) light beam, and a converging lens 114, which parallelizes the light beam again, (as shown, for example, in Figure LA). The light beam is thus widened and the angle range is reduced (for example, an exit angle 116 of the light downstream of the converging lens 114 can be less than the deflection angle 110, for example, the exit angle 116 can have a value of 20°). The adjustment optics can clearly adjust the angle of the light beam from +/−20° to +/−30°. It functions equivalently the other way around, as shown in FIG. 1B, for example, wherein the light beam narrows and the angle range increases (for example the exit angle 116 can have a value of 30°). The adjustment optics can clearly adjust the angle of the light beam from +/−30° to +/−20°.

The deflection angle and the exit angle can be measured with respect to an optical axis of the optical arrangement 100. In the configuration in FIG. 1A and FIG. 1B, the optical axis can be along a first direction 152. The deflection angle and the exit angle can be understood as angles formed by the light beams with the optical axis of the optical arrangement 100 in the scanning direction. For example, the scanning direction can be the horizontal direction (for example, a second direction 154 in FIG. 1A and FIG. 1B) as shown in the figures. Alternatively or additionally, the scanning direction can be the vertical direction (for example, a third direction 156 in FIG. 1A and FIG. 1B).

The configuration of the optical arrangement 100 typically requires large lenses since the field of view range or the beam deflection component 102 sweeps through large angles. In particular, angle reductions require large optics. For example, when a MEMS mirror is used as the beam deflection component, it typically has mechanical deflection angles of +/−15°, due to which an angle of the field of view of 60° results. Correction lenses behind the MEMS therefore have to be designed for large angles, due to which imaging errors result with simple optics, or complex lens systems have to be designed.

Alternatively, if only a smaller field of view range is desired, only part of the deflection range of the beam deflection component 102 can also be used, in that the timing of the light emission (for example of laser pulses) can be adjusted accordingly. In this case, however, only a smaller time slot would be available for the measurements. As a result, fewer measurements can be carried out (for example at a given maximum pulse rate of a laser).

A more flexible and simple adjustment of the field of view can be achieved by implementing the optical arrangement described herein, as will be explained in more detail hereinafter (for example with reference to FIG. 2A and FIG. 2B).

FIG. 2A and FIG. 2B each show an optical arrangement 200 for a LIDAR system in a schematic representation, according to various embodiments. The optical arrangement 200 can be or become arranged (for example, integrated or embedded) in a LIDAR system.

It is understood that the configuration of the optical arrangement 200 shown in FIG. 2A and FIG. 2B is only shown as an example and other configurations can be possible (for example, other types of components or components having a different configuration), as explained in more detail below. For example, each optical component illustrated as a lens can be understood as optics having one or more optical components.

The optical arrangement 200 can include a focusing arrangement 202, a beam deflection component 204 (also called a beam deflection element), and a collimating lens 206 (also called a collimator lens or collimation lens), which are described in more detail below.

FIG. 2A and FIG. 2B can be understood as a top view for a 1D scanning system (for example a top view along the MEMS axis) and as a representation of a 2D scanning system, respectively. For reasons of illustration, the part that is on the light source side (for example the laser side) of the beam deflection component 204 (for example the MEMS) is shown mirrored on the beam deflection component 204 in FIG. 2B. For example, this part rotates about the MEMS axis at twice the MEMS angle. The arrangement is as it appears from the collimating lens 206 when looking into the light source 208 (for example, into the laser) in the opposite direction to the beam.

In FIG. 2A and FIG. 2B, the beam deflection component 204 is depicted as a mirror (for example, as a “microelectromechanical system” mirror, MEMS mirror). It is understood that the depiction only serves for illustration and shows only one exemplary implementation of the beam deflection component 204. Other possible implementations are explained in more detail below.

In FIG. 2A and FIG. 2B, a focusing arrangement 202 is shown which has two optical components (for example, two lenses). It is understood that the depiction only serves for illustration and shows only one exemplary implementation of the focusing arrangement 202. According to various embodiments, the focusing arrangement 202 can include fewer than two lenses (for example only one focusing lens) or more than two lenses (and/or can include further optical components).

According to various embodiments, the optical arrangement 200 can optionally include a light source 208 which is configured to emit light. For example, the optical arrangement 200 may not include a light source 208 in the case that the LIDAR system into which the optical arrangement 200 is intended to be integrated already includes a light source.

The term “light” can be used herein to describe a bundle of light beams that propagate together (for example through the optical arrangement 200). For example, the term “light” can be used herein to describe a plurality of light beams emitted by the light source 208 (for example a plurality of laser pulses), a plurality of light beams focused by the focusing arrangement 202, a plurality of light beams deflected by the beam deflection component 204, a plurality of light beams collimated (for example parallelized) by the collimating lens 206, and the like.

The light source 208 can be configured in such a way that the light source 208 emits light (for example, light beams) in the direction of the focusing arrangement 202 (as an illustration, in the direction of the beam deflection component 204 through the focusing arrangement 202).

According to various embodiments, the light source 208 can be configured to emit light in the visible wavelength range and/or in the infrared wavelength range. For example, the light source 208 can be configured to emit light in the wavelength range from approximately 700 nm to approximately 2000 nm, for example light having a wavelength of approximately 905 nm or approximately 1550 nm.

The light source 208 can include a semiconductor light source (for example, an edge-emitting laser source) having a fast axis and a slow axis for emitting the light. The light emitted by the light source 208 can have stronger divergence in a first direction (for example the direction of the fast axis) than in a second direction (for example the direction of the slow axis), which can be perpendicular to the first direction. As an example, the fast axis can be oriented in the horizontal direction (as indicated by the arrow 210 in FIG. 2A), and the slow axis can be oriented in the vertical direction (as indicated by the arrow 212 in FIG. 2A, which comes out of the figure). However, it is presumed that any other configuration is possible, for example, the fast axis can be oriented in the vertical direction and the slow axis in the horizontal direction (for example, when the light source 208 is rotated by 90°).

As an example, the light source 208 can be or include a laser light source. For example, the light source 208 can include at least one laser diode (for example an edge-emitting laser diode or a component-side light-emitting laser diode). For example, the light source 208 can include at least one laser bar (in this case, the fast axis can be oriented in the direction of a height of an active area of the laser bar and the slow axis can be oriented in the direction of a width of the active area of the laser bar).

According to various embodiments, the focusing arrangement 202 can be configured in such a way that the focusing arrangement 202 focuses light onto a focal point 214 (also referred to as focus point or intermediate focus) of the focusing arrangement 202. The focusing arrangement 202 can be configured in such a way that the focal point 214 does not lie on the beam deflection component 204.

The beam deflection component 204 can be located downstream of the focusing arrangement 202 at a first distance (clearly, other than 0 m) from the focal point 214 of the focusing arrangement 202. The first distance is identified by reference numeral 216 in FIG. 2B. The first distance 216 can be a geometric distance between the focal point 214 and a center of the beam deflection component 204.

The collimating lens 206 can be located downstream of the beam deflection component 204 at a second distance from the focal point 214 of the focusing arrangement 202. The second distance is identified by reference numeral 218 in FIG. 2B. The second distance 218 can be a focal length (also referred to as focus length) of the collimating lens 206 or can correspond to a focal length of the collimating lens 206. Clearly, the intermediate focus 214 can be in the focal point of the collimating lens 206, so that the beams that come from the intermediate focus extend in parallel after the collimating lens 206. The second distance 218 can be a geometric distance between the focal point 214 and a center of the collimating lens 206.

According to various embodiments, the focusing arrangement 202 can be configured such that the focal point 214 of the focusing arrangement 202 is between the focusing arrangement 202 and the beam deflection component 204 (as an illustration upstream of the beam deflection component 204, as shown in FIG. 2A and FIG. 2B). Alternatively thereto, the focusing arrangement 202 can be configured in such a way that the focal point 214 of the focusing arrangement 202 lies between the beam deflection component 204 and the collimating lens 206 (clearly, downstream of the beam deflection component 204).

In the case that the intermediate focus 214 is between the focusing arrangement 202 and the beam deflection component 204 (for example, between a “fast axis” collimator lens and a MEMS), the location of the focal points via the deflection angle of the beam deflection component 204 and the field curvature of the collimating lens 206 are similar, such that the aberrations of the collimating lens 206 decrease in comparison to the fact that the intermediate focus 214 lies between the beam deflection component 204 and the collimating lens 206.

According to various embodiments, the focusing arrangement 202 can have one or more lenses. The configuration of the focusing arrangement 202 can be adjusted depending on the type of the LIDAR system (for example the type of the scan). In a LIDAR system in which the light (for example, the laser) is scanned in only one dimension over the field of view 220 (for example, the field of view 220 of the optical arrangement 200 or the field of view of the LIDAR system), the light (for example, a pulsed laser beam) is parallelized using a lens at least with respect to the fast axis and thus radiated on the beam deflection component 204. As a result, the field of view 220 is scanned. In a LIDAR system in which two dimensions are scanned using the light (for example using the laser), the beams are parallelized in both axes before they are radiated onto the beam deflection component 204.

The one or more lenses can include a first collimator lens 222-1 (for example, a first cylindrical lens). The first collimator lens 222-1 can be configured to collimate light in the direction of the fast axis of the light source 208. Clearly, the first collimator lens 222-1 can be a “fast axis” collimator (FAC) lens. According to various embodiments, for example in the case the LIDAR system is a 1D scanning system, the focusing arrangement 202 can only have a “fast axis” collimator lens.

The one or more lenses can have a second collimator lens 222-2 (for example a first cylindrical lens). The second collimator lens 222-2 can be configured to collimate light in the direction of the slow axis of the light source 208. Clearly, the second collimator lens 222-2 can be a “slow axis” collimator (SAC) lens. The second collimator lens 222-2 may be located downstream of the first collimator lens 222-1.

According to various embodiments, the focusing arrangement 202 (for example, the one or more lenses) can be controlled to change the position of the focal point. The optical arrangement 200 can include one or more processors (not shown) configured to control the position of at least one lens in order to change the position of the focal point 214 of the focusing arrangement. For example, at least one lens can be mounted on a movable mount (for example, an adjustable mount), and the one or more processors can be configured to control a movement of the mount (e.g., a rotation and/or a linear movement of a circular mount, for example).

The one or more processors can be configured to control the collimating lens 206 in accordance with the position of the focal point 214 of the focusing arrangement 202 (for example in accordance with the control of the focusing arrangement 202). The one or more processors can be configured to control the position of the collimating lens 206 (for example, the position of a mount of the collimating lens 206) in such a way that the second distance (always) corresponds to the focal length of the collimating lens 206.

According to various embodiments, the position of the intermediate focus 214 can depend on the adjustment of the lens and on the timing of the light emission (for example, laser pulses) relative to a state of the beam deflection component 204 (for example, the MEMS position). Thus, an active adjustment of the first lens behind the light source 208 can be dispensed with and the inaccuracy of the position of this lens can be corrected using a software calibration of the beam deflection component 204 (for example, a calibration of an offset angle of the MEMS position), as is explained in more detail hereinafter.

According to various embodiments, the beam deflection component 204 can be configured in such a way that the beam deflection component 204 deflects light (for example, the focused light if the focal point 214 is upstream of the beam deflection component 204, or the (not yet) focused light if the focal point 214 is downstream of the beam deflection component 204) at a deflection angle onto the field of view 220.

The beam deflection component 204 can be configured to sample (in other words, scan) the field of view 220 using the deflected light. In other words, the beam deflection component 204 can be configured (for example, controlled) to sequentially direct (for example, to deflect) light onto different regions of the field of view 220. Clearly, the beam deflection component 204 can be configured to deflect light at different deflection angles in order to illuminate different regions of the field of view 220. For example, the beam deflection component 204 can deflect light at a first deflection angle to direct the light (for example first light beams 224-1) in a first direction, and can deflect light at a second deflection angle (the second deflection angle is identified by the reference numeral 228 in FIG. 2B) to direct the light (for example, second light beams 224-2) in a second direction. Solely as an example, the first deflection angle can have a value of 0° and the second deflection angle 218 can have a value of 20°.

The beam deflection component 204 can be configured (for example, controlled) to scan the field of view 220 using the deflected light in one direction (for example, in a 1D scanning LIDAR system) or in two directions (for example, in a 2D scanning LIDAR system). The scanning direction can be the horizontal direction or the vertical direction, for example. The deflection angle can be an angle that the light forms with a perpendicular to the surface of the beam deflection component 204 (for example, an angle with respect to the optical axis of the optical arrangement 200 in the horizontal or vertical direction).

According to various embodiments, the scanning direction of the beam deflection component 204 can be parallel to one of the axes of the light source 208. For example, the beam deflection component 204 can be configured to scan in the direction of the fast axis of the light source 208. In this configuration, the deflection angle can be an angle with respect to the optical axis of the optical arrangement 200 in the direction of the fast axis. Alternatively or additionally, the beam deflection component 204 can be configured to scan in the direction of the slow axis of the light source 208. In this configuration, the deflection angle can be an angle with respect to the optical axis of the optical arrangement 200 in the direction of the slow axis.

As an example, the deflection angle (for example a first and/or a second deflection angle element) can have a value in a range from approximately −60° to approximately +60° with respect to the optical axis of the optical arrangement 200, for example in a range from approximately −30° to approximately +30°.

According to various embodiments, the beam deflection component 204 can have a plurality (for example, at least two) of operating states (also referred to as actuation states). Each operating state can be associated with a respective deflection angle. For example, the beam deflection component 204 can be configured such that it deflects the light at the first deflection angle in a first operating state and that it deflects the light at the second deflection angle in a second operating state.

The one or more processors (for example, the processors described above or further processors) of the optical arrangement 200 can be configured to control the beam deflection component 204 (for example, to define the deflection angle). For example, the one or more processors can be configured to control the beam deflection component 204 in such a way that it enters one operating state of the plurality of operating states. Clearly, the one or more processors can be configured to control the beam deflection component 204 in such a way that it sequentially enters each operating state of the plurality of operating states.

According to various embodiments, the one or more processors can be configured to control the light source 208 in such a way that it emits light in accordance (for example, in synchronization) with an operating state of the beam deflection component 204. Clearly, the light source 208 can be controlled in such a way that it emits pulsed light in synchronization with the sequential scanning of the operating states.

As an example, the beam deflection component 204 can be a microelectromechanical mirror configured to oscillate around an actuation axis (for example, oriented in the vertical direction) of the microelectromechanical mirror (also referred to as a MEMS axis). The microelectromechanical mirror can deflect light (for example, the first light beams 224-1) at a first deflection angle if the microelectromechanical mirror is at a first tilt angle with respect to the actuation axis, and can deflect light (for example, the second light beams 224-2) is at a second deflection angle if the microelectromechanical mirror is at a second tilt angle with respect to the actuation axis.

According to various embodiments, the beam deflection component 204 (for example the MEMS) can cause the focal point 214 to be shifted in the direction of the scanning direction (for example in the direction of the fast or slow axis, respectively) as seen from the collimating lens 206, and thus the direction of the parallel beams behind the collimating lens 206, as shown in FIG. 2A and FIG. 2B. Each position of the focal point 214 can be associated with an exit angle downstream of the collimating lens 206 (in other words, the exit angle of the parallelized light can be dependent on the position of the focal point 214). The displacement between the (virtual) position of a first focal point 214-1 and the (virtual) position of a second focal point 214-2 is identified by reference numeral 226 in FIG. 2B.

The deflection angle of the deflected light downstream of the beam deflection component 204 can define a virtual position of the focal point 214 of the focusing arrangement 202 with respect to the collimating lens 206. Each virtual position can be at the same distance (for example, corresponding to the focal length of the collimating lens 206) from the collimating lens 206 as every other virtual position. Clearly, a location 215 of all intermediate foci (each associated with a deflection angle) can be defined (shown in FIG. 2B as observed from the collimating lens 206).

For example, the first deflection angle can define or be associated with a first virtual position of the focal point 214 with respect to the collimating lens 206 (the first deflection angle can define a first virtual focal point 214-1, and thus a first exit angle downstream of the collimating lens 206). The collimating lens 206 can thus observe a first “virtual” focusing arrangement 202-1 (including a first lens 222-3 and a second lens 222-4) and a first “virtual” light source 208-1.

For example, the first deflection angle can define or be associated with a second virtual position of the focal point 214 with respect to the collimating lens 206 (in other words, the second deflection angle can define a second virtual focal point 214-2 and thus a second exit angle downstream of the collimating lens 206). The collimating lens 206 can thus observe a second “virtual” focusing arrangement 202-2 (including a first lens 222-5 and a second lens 222-6) and a second “virtual” light source 208-2.

In the case that the beam deflection component 204 is a MEMS mirror, the displacement of the focal point 214 can be approximately proportional to the distance of the focal point 214 to the MEMS axis (also referred to as the MEMS rotation axis), multiplied by the tangent of twice the MEMS deflection angle. In this configuration, the change of the beam direction after the collimating lens 206 can be approximately proportional to the arctangent of the quotient between deflection of focal point 214 in the direction perpendicular to the scanning direction (for example, in the direction of the slow axis) and focal length of the collimating lens 206. As a first approximation, these relationships allow any beam directions to be generated from any MEMS deflection angles.

According to various embodiments, the one or more processors can be configured to control the beam deflection component 204 in such a way that it enters an operating state to define a predefined virtual position of the focal point 214 of the focusing arrangement 204 with respect to the collimating lens 206. Clearly, the one or more processors can be configured to change the deflection angles in such a way as to compensate for inaccuracies of the focusing arrangement 202. For example, the one or more processors of the optical arrangement 200 can be configured to assign an offset angle to each tilt angle of the microelectromechanical mirror, such that each tilt angle defines a predefined virtual position of the focal point 214 of the focusing arrangement 202 in relation to the collimating lens 206.

The one or more processors can furthermore be configured to control the timing of the light emission from the light source 208 in such a way that the light source 208 emits light in synchronization with an operating state of the beam deflection component 204 that defines a predefined position of the focal point 214 with respect to the collimating lens 206. In other words, the one or more processors can be configured to control the light source 208 to emit light only when the beam deflection component 204 is in an operating state that defines a predefined (for example, desired) position of the focal point 214.

According to various embodiments, the collimating lens 206 can be configured to adjust the exit angle of the light in the field of view 220. Clearly, the collimating lens 206 can be used to adapt the deflection angle range of the beam deflection component 204 to any (for example, predefined) exit angle range.

As an example, the collimating lens 206 can be or include a cylindrical or acylindrical lens (for example, for a 1D scanning LIDAR system) or an aspherical lens (for example, for a 2D scanning LIDAR system). For example, the collimating lens 206 can be a cylindrical lens having refractive power in the direction of the scanning direction (for example, in the direction of the fast axis).

The collimating lens 206 can be configured in such a way that it images the deflected light coming from the focal point 214 onto collimated light at an exit angle. For example, the collimating lens 206 can be configured in such a way that it maps light (for example, the first light beams 224-1) which is deflected at a first deflection angle and comes into the collimating lens 206 from a first focal point 214-1 (and enters at a first entrance angle), onto collimated light at a first exit angle, and that it maps light (for example, the second light beams 224-2) which is deflected at a second deflection angle and comes into the collimating lens 206 from a second focal point 214-2 (and enters at a second entrance angle) onto collimated light at a second exit angle (the second exit angle is identified by reference numeral 230 in FIG. 2B). For example, the exit angle can be calculated as the arctangent of the tangent of twice the deflection angle multiplied by the ratio of the first distance 216 to the second distance 218.

As an example, the collimating lens 206 can be configured in such a way that the exit angle has a value in a range from approximately −20° to approximately +20° with respect to the optical axis of the optical arrangement 200, for example in a range from approximately −5° to approximately +5°, for example in a range from approximately −50° to approximately +50°. In the case of the optical arrangement 200, the angle adjustments can thus be implemented using simple lenses, in particular for small field of view angles.

If only a small range of angles were used by the beam deflection component 204 (for example MEMS), the beam deflection component 204 would be unusable a large part of the time, since otherwise angles would be irradiated which are not in the field of view. In contrast, when using the optical arrangement 200, more time is available for the measurements, as a result of which either a higher frame rate or a greater range can be achieved via more averaging. As an example, with a field of view adjustment from 60° (MEMS) to 6° (required field of view), 5-10 times as much time is available for the measurement, which results in an increase in the frame rate by this factor, or, if the time is used for more averaging, the range can be increased by a factor of 1.2 to 1.8. When the field of view is reduced, the beam deflection component 204 (for example, the MEMS) can be irradiated using a narrower light beam. As a result, larger extended light sources, or larger emission angles of the light source, or smaller MEMS mirrors can be used.

According to various embodiments, the optical arrangement 200 can optionally include one or more further optical elements (not shown) for adjusting the light downstream of the collimating lens 206.

As an example, the optical arrangement 200 can include a coarse angle control component (for example, a liquid crystal polarizing grating) for controlling the propagation direction of light into the field of view 220. The coarse angle control element can be configured to provide a coarse adjustment of the exit angle (for example, to deflect the light output from the collimating lens at a discrete deflection angle).

As a further example, the optical arrangement 200 can have a correcting lens (for example, a zoom lens) which is configured in such a way that it outputs the light received from the collimating lens 206 at a corrected exit angle (clearly, the correcting lens can variably adjust the exit angle downstream of the collimating lens 206). The one or more processors of the optical arrangement 200 can be configured to control the correction lens to change the corrected exit angle downstream of the correction lens.

### LIST OF REFERENCE NUMERALS

optical arrangement 100
beam deflection component 102
field of view 104
first light beam 106
second light beam 108
deflection angle 110
scattering lens 112
converging lens 114
exit angle 116
first direction 152
second direction 154
third direction 156
optical arrangement 200
focusing arrangement 202
first focusing arrangement 202-1
second focusing arrangement 202-2
beam deflection component 204
collimating lens 206
light source 208
first light source 208-1
second light source 208-2
arrow/fast axis 210
arrow/slow axis 212
focal point 214
first focal point 214-1
second focal point 214-2
location of intermediate foci 215
first distance 216
second distance 218
field of view 220
first collimator lens 222-1
second collimator lens 222-2
first collimator lens 222-3
second collimator lens 222-4
first collimator lens 222-5
second collimator lens 222-6
first light beams 224-1
second light beams 224-2
displacement 226
deflection angle 228
exit angle 230

1. An optical arrangement (200) for a LIDAR system, the optical arrangement (200) having:
a focusing arrangement (202) which is configured in such a way that it focuses light onto a focal point (214) of the focusing arrangement (202),
a beam deflection component (204) arranged downstream of the focusing arrangement (202) at a first distance (216) from the focal point (214) of the focusing arrangement (202), wherein the beam deflection component (204) is configured to direct the light at a deflection angle onto a field of view (220), and
a collimating lens (206) arranged downstream of the beam deflection component (204) at a second distance (218) from the focal point (214) of the focusing arrangement (202),
wherein the second distance (218) corresponds to a focal length of the collimating lens (206), and
wherein the collimating lens (206) is configured to parallelize the light from the focal point (214) of the focusing arrangement (202).

2. The optical arrangement (200) as claimed in claim 1,
wherein the deflection angle of the deflected light downstream of the beam deflection component (204) defines a virtual position of the focal point (214) of the focusing arrangement (202) with respect to the collimating lens (206).

3. The optical arrangement as claimed in claim 1 or 2,
wherein the beam deflection component (204) has at least two operating states,
wherein the beam deflection component (204) is configured in such a way that it deflects the light at a first deflection angle with respect to the optical axis of the optical arrangement (200) in a first operating state of the at least two operating states, and
wherein the beam deflection component (204) is configured in such a way that it deflects the light at a second deflection angle with respect to the optical axis of the optical arrangement (200) in a second operating state of the at least two operating states.

4. The optical arrangement (200) as claimed in any one of claims 1 to 3,
wherein the collimating lens (206) is configured in such a way that it maps the light coming into the collimating lens (206) from the focal point (214) of the focusing arrangement (202) onto collimated light at an exit angle.

5. The optical arrangement (200) as claimed in claim 4,
wherein the exit angle of the collimated light downstream of the collimating lens (206) is dependent on a ratio between the first distance (216) and the second distance (218).

6. The optical arrangement as claimed in any one of claims 1 to 5,
wherein the deflection angle has a value in a range from approximately −60° to approximately +60° in relation to the optical axis of the optical arrangement (200), and/or
wherein an exit angle of the collimated light downstream of the collimating lens (206) has a value in a range from approximately −20° to approximately +20° with respect to the optical axis of the optical arrangement (200).

7. The optical arrangement (200) as claimed in any one of claims 1 to 6,
wherein the collimating lens (206) is a cylindrical lens, an acylindrical lens, or an aspheric lens.

8. The optical arrangement (200) as claimed in any one of claims 1 to 7,
wherein the focusing arrangement (202) is configured in such a way that the focal point (214) of the focusing arrangement (202) lies between the focusing arrangement (202) and the beam deflection component (204), or
wherein the focusing arrangement (202) is configured in such a way that the focal point (214) of the focusing arrangement (202) lies between the beam deflection component (204) and the collimating lens (206).

9. The optical arrangement (200) as claimed in any one of claims 1 to 8,
wherein the beam deflection component (204) is or has a microelectromechanical system.

10. The optical arrangement (200) as claimed in any one of claims 1 to 9, furthermore having:
a light source (208) configured to emit light in the direction of the focusing arrangement (202).
